(19) United States
(12) Patent Application Publication
(10) Pub. No.: US 2006/0064345 A1
(43) Pub. Date: Mar. 23, 2006

(54) Method for monitoring the registration of road tolls

(75) Inventor: Werner Biet, Hennef (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/121,100

(22) Filed: May 4, 2005

Related U.S. Application Data
(63) Continuation of application No. 10/871,053, filed on Jun. 21, 2004, now abandoned.
Application No. 10/871,053 is a continuation of application No. 10/470,721, now abandoned.

(30) Foreign Application Priority Data
Jan. 31, 2001 (DE) 101 04 502.6

(51) Int. Cl. G07B 15/00; G08G 1/065

(52) U.S. Cl. 705/13; 340/928

(57) ABSTRACT

A monitoring method for registration of road tolls uses a monitoring system with a plurality of registration devices for vehicle information, and a trigger device for the correctly timed activation of the registration devices. The individual registration devices are activated at times at which the spatial arrangement of the vehicle and the respective registration device which registers vehicle information is at an optimum. Various vehicle information items which are registered separately in spatial and chronological terms by the registration devices are assigned by the monitoring system to the vehicle and to a reference time.

This application is a continuation of Ser. No. 10/871,053, filed Jun. 21, 2004, which was a continuation of Ser. No. 10/470,721, filed Jul. 31, 2003, and claims the priority of German patent application 101 04 502.6, filed 31 Jan. 2001 (PCT Application No. PCT/EP01/14439, filed 08 Dec. 2001), the disclosure of which is expressly incorporated by reference herein.

### BACKGROUND AND SUMMARY OF THE INVENTION

The invention relates to a method for monitoring the registration of road tolls with a monitoring system.

U.S. Pat. No. 5,757,286 describes such a monitoring system, which is fixed and registers vehicle information via registration devices and assigns the vehicle information to the time of monitoring.

International Patent Document WO 99/66455 describes a monitoring system of this type, which is used for fixed, automatic monitoring. A vehicle device installed in a vehicle carries out the registration of tolls autonomously on board the vehicle. The satisfactory payment of the tolls is monitored by the road-side fixed monitoring system. For this purpose the monitoring system communicates with the vehicle device by means of communication devices. The passing vehicle is assigned to a specific vehicle class with the aid of sensors which serve as registration devices for optical and acoustic measured values. The monitoring system has a registration device for optically registering the number plate of the passing vehicle.

One object of the present invention is to provide an improved monitoring method, in which each vehicle on each road section can be monitored by registering usable vehicle information.

This and other objects and advantages are achieved by the monitoring method according to the invention, which achieves a good quality level of the registered vehicle information by registering such via individual registration devices when the spatial arrangement between the vehicle and the registration device is at an optimum. This is the case, for example, with a camera for recognizing registration numbers when the camera is placed obliquely in front of the vehicle. For infrared communication, for example, a line-of-sight connection is necessary between the registration device and the infrared communication device in the vehicle.

The vehicle information which is registered in the monitoring system is registered separately in spatial and chronoligical terms and vehicle information which is associated with a vehicle is assigned to this vehicle. The vehicle information which has been registered by a monitoring system is assigned to a reference time. The reference time can be a single time, such as the time of the first or the last registration, the mean between the first and last registration times or the time at which the vehicle is located spatially in the center of the registration area of the monitoring system. When necessary, a plurality of reference points, to which the values are then assigned, can also be selected. Assignment makes it possible to define which vehicle information is associated with which vehicle, and to assign when the vehicle has passed the monitoring system, the vehicle speed being used to compensate for the difference between the registration time and the reference time. To do this, vehicle information at the registration time is transformed into vehicle information at the reference time. This facilitates the use of vehicle information in other methods and permits the registration devices to be mounted in a spatially clustered fashion in order to avoid a spatially extended arrangement.

The monitoring method according to the invention may be fixed or transportable. All three parts of the monitoring system basically register the same vehicle information, but can be used in different ways.

A fixed monitoring system permits automatic monitoring operation without the use of additional personnel. The fixed monitoring system provides advantages in carrying out a preselection as part of a stationary monitoring process as it registers the vehicle information of all the passing vehicles without additional expenditure. When stationary monitoring is carried out, the transportable monitoring system is used in conjunction with the fixed monitoring system. Mobile monitoring is based on the transportable monitoring system. The flexible use of fixed and transportable monitoring systems therefore results in a monitoring concept composed of automatic monitoring, mobile monitoring and stationary monitoring.

This makes it possible to monitor each vehicle on each freeway section and to keep the use of the monitoring systems flexible according to various criteria, for example the highest possible detection rate of people making incorrect payments and people who are failing to pay, the smallest possible deployment of personnel, the smallest possible number of incorrect detections, the smallest possible expenditure on collecting fines and the acquisition of evidence which will as far as possible stand up in court.

The registration devices can be activated automatically or manually. For automatic monitoring 200.1 (FIG. 2), the registration devices is triggered automatically, permitting the monitoring system to be operated without the direct deployment of personnel.

The registered vehicle information comprises information on the vehicle's movement, particularly lane changes, acceleration, braking operations and speed. This permits the vehicle information which is not registered simultaneously within a monitoring system to be assigned to a vehicle and to a reference time.

The detection of number plates is advantageous, for example if the monitoring system cannot communicate with the vehicle (for example because the vehicle does not have a vehicle device) by virtue of the fact that it then registers only the number plate and compares it with the content of databases in order to determine there, for example, whether there is a valid driving authorization for the detected vehicle class and for this time.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a block circuit diagram of a monitoring system with external interfaces;

FIG. 2 shows a block circuit diagram of the monitoring system with internal interfaces;

FIG. 3 shows a diagram of the first part of a monitoring sequence;

FIG. 4 shows a diagram of the second part of a monitoring sequence;

FIG. 5 shows the geometric arrangement of the sensors of the monitoring system;

FIG. 6 shows a plan view of the measurement areas of the monitoring system on the road;

FIG. 7 shows the internal interfaces and data flows in the monitoring system; and

FIG. 8 shows the arrangement of an automatic and stationary monitoring facility on a section of freeway.

### DETAILED DESCRIPTION OF THE DRAWINGS

In the following description, “toll” means fees that are to be paid for use of a road. The objective of the monitoring is to ensure that the obligation to pay a toll is enforced to a high degree, while treating all persons obliged to pay a toll equally, by registering persons who do not pay and persons who pay the incorrect amount, by collecting at a later time tolls which have not been paid and by imposing fines.

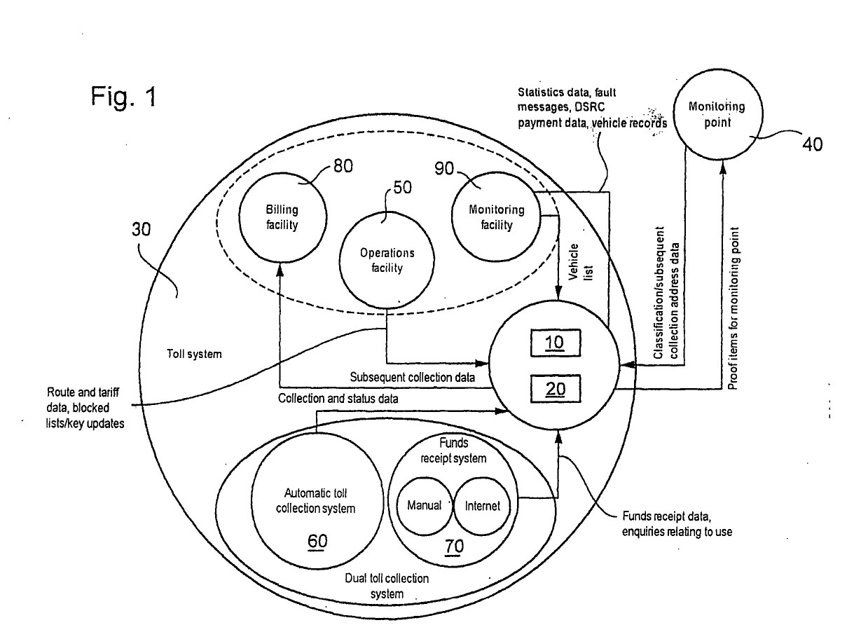

The integration of the monitoring system 10 with monitoring control center 20 into the toll system 30 is illustrated in FIG. 1. The monitoring system 10 receives road data and tariff data from the operations facility 50 in order to determine how high the toll is for the vehicles to be monitored. Key updates are used for transmitting data in a protected fashion. The data relating to the toll paid in the dual toll-collection system is transmitted from the subsystems of said dual toll-collection system to the monitoring system 10. The contents which are determined during the monitoring process are transferred to relevant locations for processing and then passed on via the monitoring system 10 to the billing facility 80 for subsequent collection.

The method according to the invention includes the following forms of monitoring: automatic monitoring 200.1, stationary monitoring with automatic preselection, mobile monitoring and operational monitoring.

The automatic monitoring processes check the satisfactory payment of tolls in a fixed fashion at fixed locations in the road network for which tolls are to be paid, without the assistance of monitoring personnel and without stopping the vehicles. In what follows, the monitoring system 10 is an “automatic monitoring system”. One hundred fifty of the 300 automatic monitoring processes are additionally performed by automatic preselection for a stationary monitoring process. Here, vehicles which are indicated by the automatic preselection are led off by personnel from the monitoring point 40 and monitored in the stopped state.

For mobile monitoring, monitoring vehicles move along interspersed in the flowing traffic, and vehicles for which monitoring is necessary are extracted from the traffic at suitable stopping points in order to monitor whether the stopped vehicle has complied with the obligation to pay a toll, and if necessary initiate sanctions. Below, “mobile monitoring systems” mean transportable monitoring systems which are used for mobile monitoring.

In contrast to the other forms of monitoring, operational monitoring does not check the vehicles directly while the freeway is being used but rather monitors operational procedures and vehicles subsequently to determine whether routes for which a toll is due have been used.

The combination of these forms of monitoring and the configuration provided for them ensures that each vehicle on each section of freeway can be monitored.

Irrespective of the form of monitoring, the monitoring process is composed of the following basic functions: determination of the contents of the use of a road for which a toll is due by a vehicle which is liable to pay a toll, determination of the contents by checking the payment of the toll either directly on the vehicle device, in the database of the central system or by checking automatically recorded evidence, subsequent collection of the toll when an infringement is determined, implementation of proceedings for collecting a fine, if necessary enforcement of notices for subsequent collection of tolls and the imposition of fines. The monitoring processes register all the vehicles which are liable to pay tolls irrespective of the form of monitoring and the selected toll-collection system and monitor in particular if no toll at all has been paid.

This is ensured because all the monitoring systems 10 receive data on the vehicle which is to be monitored and on associated receipts of funds—specifically both from the vehicle devices used in the automatic toll-collection system 60 and from the fund receipt database of the fund receipt systems 70.

The structural and technical devices of the monitoring system 10 are summarized in the following table and explained in brief:

| Component | Description |
|---|---|
| Central | |
| Monitoring | The monitoring center 20 of the toll system 30 and |
| center 20 | is equipped with all the necessary computers, |
| | peripherals, communication paths, personnel and |
| | other resources. |
| Workstations for | PC-supported workstations in the monitoring |
| classifying, | center 20. |
| identifying and | |
| determining | |
| contents | |
| Workstations for | PC-supported workstations in the monitoring point |
| generating orders | 40 which have access to the evidence data of the |
| for the imposition of | monitoring center 20 via a fixed link. |
| fines | |
| Automatic fixed | |
| monitoring | |
| Automatic | Fixed, fully automatic monitoring systems which |
| monitoring 200.1 | detect vehicles in all lanes including the hard |
| | shoulder, classify them and check them for correct |
| | payment of tolls. |
| | They communicate with the monitoring center 20 |
| | and the vehicle devices of passing vehicles. The |
| | transmission is protected cryptographically. |
| | Special, defined monitoring systems can perform |
| | the function of automatic preselection for |
| | stationary monitoring. |
| Stationary | |
| monitoring | |
| Switch cabinet | Fixed device for the wire-free connection of the |
| | leading-off aids to the monitoring station 200.3. |
| | Dependent on the local conditions, mast for |
| | holding the antenna for communication with the |
| | automatic monitoring system. |
| Leading-off aids | Transportable devices which can represent an |
| | image, the detected registration number and the |
| | result of the determination of the contents by the |
| | preceding automatic monitoring 200.1. |
| Monitoring system | Data radio-enabled, transportable computers for |
| for stationary | supporting the determination of the contents for |
| monitoring | vehicles which are led off to a monitoring station |
| (transportable | 200.3. |
| monitoring system) | They have a GSM interface for calling current |
| | funds receipt data for a specific vehicle registration |
| | number in the monitoring center 20 and the |
| | possibility of interrogating data from the vehicle |
| | device via DSRC or a cable link. |
| Mobile monitoring | |
| Mobile monitoring | Supports mobile monitoring while traveling and |
| system | after the truck has been led off. |
| (transportable | The monitoring systems are equipped with an |
| monitoring system) | autonomous section-detection module for |
| | detecting and representing the section which is |
| | being traveled on at a particular time and are |
| | connected to a GPS antenna in the vehicle. The |
| | data of the vehicle device of a monitored truck is |
| | interrogated via a DSRC transceiver component. |
| | The communication with the monitoring center |
| | 20 is carried out via a suitable communications |
| | interface (GSM/GPRS). |

The interfaces and data flows of the monitoring system 10 which are external from the point of view of the monitoring system 10 are represented in FIG. 1.

The monitoring system 10 receives collection data from the automatic toll-collection system by reading out from the vehicle devices during a monitoring process.

The monitoring system 10 receives funds receipt data from the fund receipt system. It carries out monitoring in conjunction with the route data and tariff data from the operations facility 50 and supplies subsequent collection data to the billing facility 80 in the case of infringements of the obligation to pay a toll. The billing facility 80 processes the subsequent collection data in a way which is analogous to that for the funds data which it has received via the dual toll-collection system.

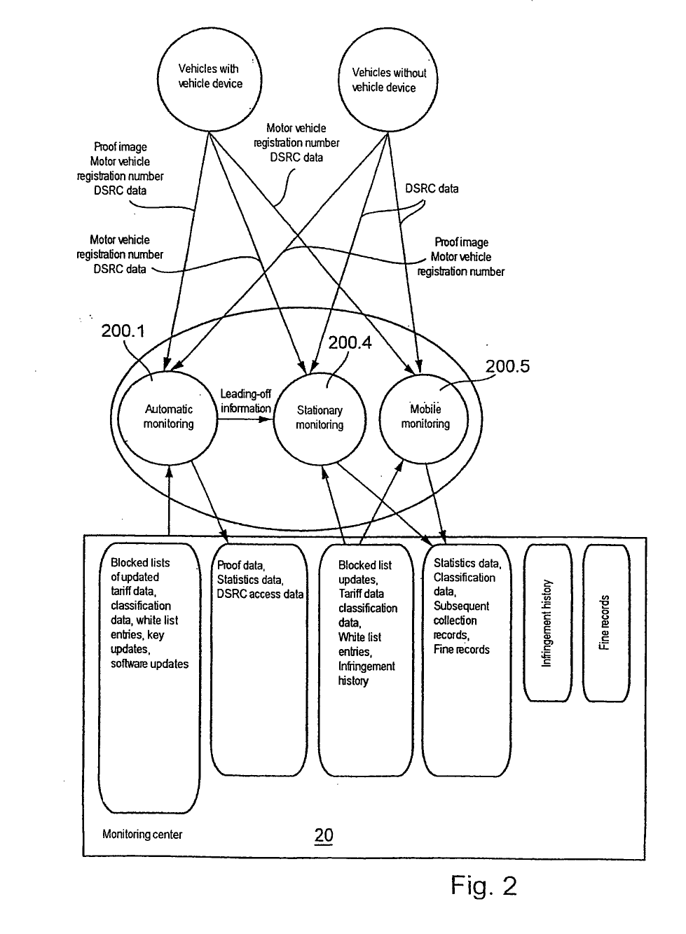

FIG. 2 shows the monitoring-internal data flows between the monitoring center 20 and monitoring systems 10 in detail. The forms of monitoring are: automatic monitoring 200.1, stationary monitoring 200.4 and mobile monitoring 200.5.

The automatic monitoring 200.1, with the associated subsequent processing, subsequent collection and treatment of infractions of rules by the monitoring point 40, takes place in the monitoring center 20.

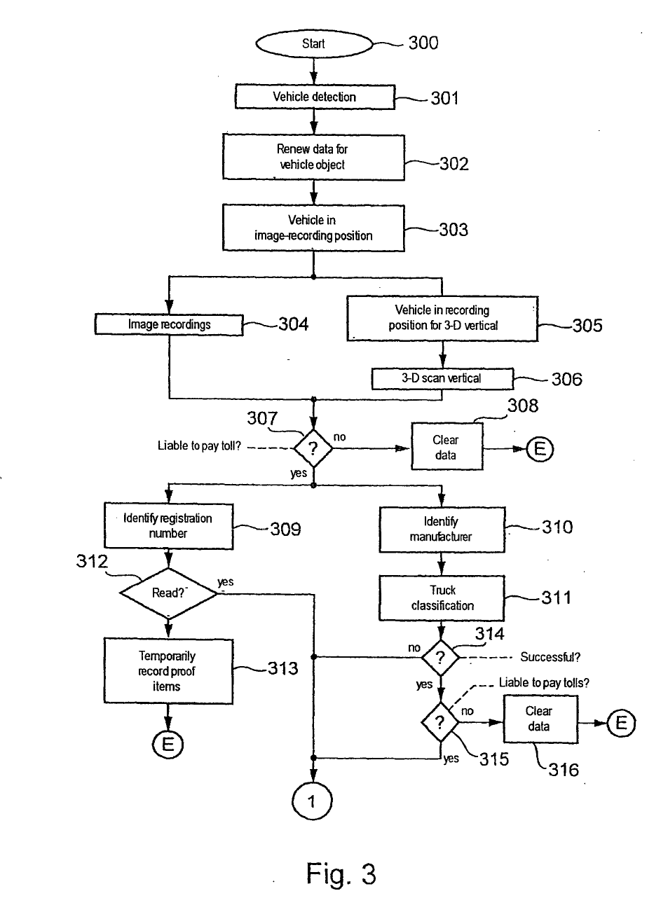

Inter alia, automatic monitoring processes 200.1 are used for determining the contents, are installed on bridges and carry out the monitoring of all the passing vehicles in the following steps (FIG. 3): detection of vehicles, step 301, classification of vehicles, step 311, recording and determination of the motor vehicle registration number, step 309, DSRC communication with the vehicle device (DSRC: Dedicated Short-Range Communication), step 317, decision process and, if appropriate, storage of evidence, steps 318 to 331.

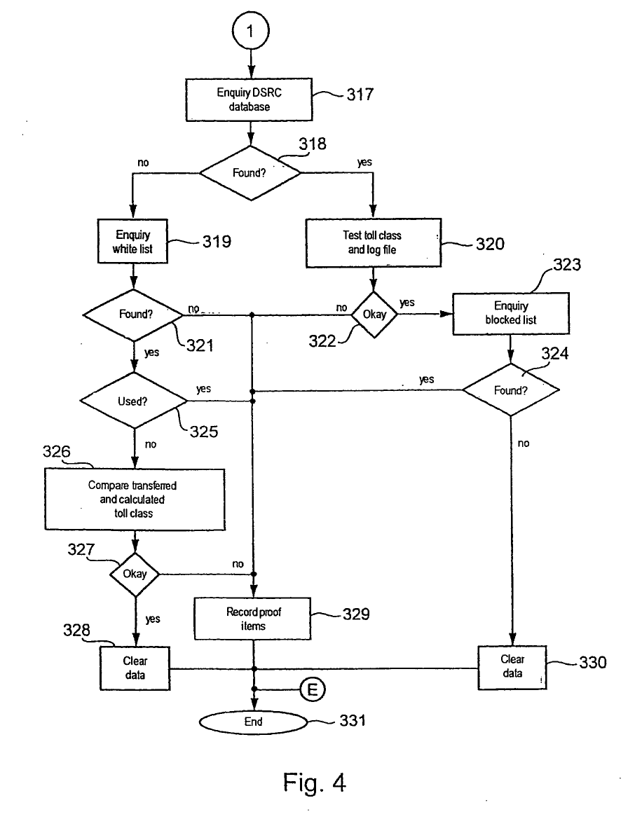

The monitored points are equipped with monitoring systems 10 in such a way that all the lanes of the monitoring cross section including the hard shoulder are registered and monitored. In the process, changes of lanes as far as the direct vicinity of the monitoring cross section are registered in order to be able to assign all the registered data reliably to the correct vehicle image even under difficult traffic conditions (congestion). The action diagram in FIG. 3 and FIG. 4 shows the provided sequence of an automatic monitoring process. Using special sensors it is possible for vehicles which are due to pay tolls to be detected with a high degree of reliability and for their path to be pursued, step 301. This takes place irrespective of whether there is an obligation to pay a toll, whether the toll has been paid at all and what method of payment has been used to do so. The sensors can detect vehicles which are obviously not liable to pay a toll, such as passenger cars and motorbikes as such, and of avoiding taking a picture of these vehicles.

As soon as a vehicle which has been detected as possibly liable to pay a toll has approached the monitoring bridge to a distance of approximately 10 to 12 m, a digital overview, in steps 305 and 306, and a plurality of digital registration number images are recorded in order to cover the entire range of the lanes—step 304. These are used to identify the vehicle and can be used later as proof. The number plate is searched for in the image, the country of origin is determined and the motor vehicle number evaluated, step 309. For this purpose, an OCR (OCR: Optical Character Recognition=automatic identification of characters) method is implemented for reading the registration number. The monitoring system 10 determines the country of origin as far as possible from the letter/number combination. If this is not sufficient, separation characters and the character font are used for the classification of nationalities. Reliable recognition of the country of origin is not necessary for fault-free decision for a particular case.

In parallel with this, DSRC communication is used to check whether the vehicle is equipped with a vehicle device, and feeds information back to the vehicle device, step 317. If there is no response by the vehicle device during the DSRC communication or it signals a fault, it assumes that the vehicle is participating in the funds receipt system, branch “no” of step 319. The registration number which is determined is then reconciled with a so-called white list which contains all the funds receipt operations which have been performed for this time and for this monitored section. The white list is present in a database in the monitoring center 20. Access takes place via a fixed line-bound data communication link.

When the vehicle passes the monitoring bridge, it is classified using a measurement, step 311, insofar as this is possible owing to measurable parameters.

If any doubts remain after the preceding steps, about the declared toll class, the motor vehicle registration number or whether the obligation to pay a toll has been fulfilled correctly, the automatic recording and protection of proof items takes place in all cases, step 329.

Optionally, the automatic monitoring system 10 makes available all the information—via an interface which can be activated—for subsequent stationary monitoring which is required to select the vehicles which are to be diverted.

In order to determine the toll class and level of tolls, in the course of the determination of facts, each vehicle which passes the monitoring cross section is detected automatically and it is determined as far as possible whether it is liable to pay a toll or not, steps 311, 314, 315.

For classification of a vehicle, various measurement data are determined as it passes through the monitored area, steps 304, 305, 306. Its assignment to a weight class is based on the physical number of axles, the width of the driver's cab, the height of the driver's cab, the overall height and the overall width.

In order to be able to assign vehicles between 7.5 t and 18 t to a permitted overall weight more accurately, there is provision for possible brand symbols of manufacturing firms to be determined optoelectronically. The assignment can then be carried out using specific data on the model series of these companies, step 310.

Furthermore, during the classification in step 311, the vertical profile of the vehicle determined in step 306 is evaluated in order to be able to distinguish trucks from buses and to recognize trucks with and without trailers. Trailered couplings which are present can be clearly discerned on the profiles which are recorded. Individual vehicles can be freed from the obligation to collect a toll even if they fulfill the physical conditions for said obligation. This is determined—after the determination of the motor vehicle registration number—online by reference to a list which is stored in the monitoring center 20 and which contains all the registration numbers of trucks which are not liable to pay a toll, step 319 (FIG. 4). The list also contains registration numbers of vehicles which have already been identified in the subsequent manual processing as not liable to pay a toll or registered as such. If there is an interface with the Federal Motor Vehicle Authority available, the enquiry for German vehicles is made via a list called up from there.

After the toll class has been detected, the level of toll for the section traveled on can be determined by reference to the calculation parameters and formulas stored in the monitoring system 10 and compared with the toll actually paid. If the question of obligation to pay a toll cannot be clarified unambiguously on the basis of the external features and if the monitoring center 20 does not have a corresponding classification entry, an infraction is hypothetically assumed, step 313 or 329, a proof data record is assembled and it is then presented to the monitoring center 20 for further manual clarification.

A reliable distinction between vehicles that are liable to pay tolls and those that are not is thus ensured, excepting only those dubious cases which can be clarified only through manual post-processing. Their number will be kept as small as possible by the automatic monitoring system 10 using its technical equipment and the detection of the manufacturer. In order to arrive at a decision in a particular case, the monitoring system 10 automatically carries out a pre-decision as to whether the holder or the driver of a vehicle is someone who pays correctly or someone who avoids paying a toll. The latter also includes holders or drivers of incorrectly declared vehicles. In order to check this, it is necessary to evaluate the DSRC communication, the vehicle's own classification data and the classification information of the monitoring center 20 and of the motor vehicle registration number which is determined.

Whether or not a vehicle participates in the automatic toll-collection system can be clarified by means of the attempt of the monitoring system 10 to establish a DSRC communication with a vehicle device which is possibly present, step 317 (FIG. 4).

If a vehicle device responds correctly, it signals its operational capability, step 318, branch “yes”. If the toll-related data from the acknowledgement—such as motor vehicle registration number, toll class and level of toll, step 320—correspond to the data of the automatic classification and determination of the registration number, step 322, the vehicle is classified as that of a person who pays correctly (branch “yes” from step 322). The recorded image data is cleared if there is no suspicion of tampering and the vehicle device or the collection card are not on a blocked list (step 323). If there is no response from the vehicle device or if it signals a fault during the DSRC communication, it is assumed that the vehicle is participating in the funds receipt system (branch “no” of step 318). The registration number which is determined optoelectronically is then reconciled with the white list in the monitoring center 20, which contains all valid funds receipt operations for the section that is to be monitored and the monitoring time (step 319, decision in step 321).

In this way, persons who pay correctly are also detected and are not considered further. The data from persons who pay correctly are, however, stored in the monitoring system 10 until the expiration of the validity of the use authorization in order to be able to prove its possible multiple use. In this way it is also possible to reliably rule out a situation in which incorrect decisions occur owing to doubles—i e., vehicles with the same registration number from different countries of origin. This is because in this case it is possible, by means of manual post-processing, to determine which user is the person avoiding the payment of tolls.

The data on unambiguously detected incorrect payers and non-payers which is necessary to provide proof is registered, stored in a cryptographically protected form and passed on to the monitoring center 20. If the situation cannot be determined unambiguously by the monitoring system 10 because, for example, the registration number of a vehicle without a vehicle device could not be read automatically, the data which is necessary for the decision is passed on in the same way to the monitoring center 20.

If it is not possible to detect unambiguously an obligation to pay a toll in the case of a vehicle without a vehicle device, all data necessary to provide proof is also passed on to the monitoring center 20 for clarification. In another procedure, a large number of vehicles which are liable to pay tolls and types of vehicles could not be systematically monitored as there is a series of vehicle models which are entirely or partially of identical design and whose permitted overall weight may lie above or below the limit for the obligation to pay a toll. The automatic monitoring 200.1 could however in principle also follow the other procedure.

The following table lists the cases which are to be distinguished:

| Case group | | |
|---|---|---|
| No. | Case group | Explanation |
| 1 | Not liable to pay a toll | Detected by reference to the |
| (is not | | vehicle features or the |
| registered) | | registration number |
| 2 | Person who makes | Functioning vehicle device |
| (is not | correct payments | |
| registered) | detected | |
| 3 | Registration number | No DSRC communication, |
| | not detected | receipt of funds cannot be |
| | | checked |
| 4 | Doubts about | Vehicle features unclear |
| | obligation to pay toll | |
| 5 | Doubts about | DSRC communication present |
| | fulfillment of | but assignment to a vehicle |
| | obligation to pay toll | not unambiguously possible |
| | | because registration number |
| | | cannot be read |
| 6 | Incorrect payer | Different toll class |
| | detected | |
| 7 | Non-payer detected | No functioning vehicle device |
| | | and no funds receipt operation |
| | | corresponding to registration |
| | | number |
| 8 | Non-payer detected | Receipt of funds for the vehicle |
| | | is used twice |
| 9 | Non-payer detected | No payment proof for the |
| | | current section transmitted via |
| | | DSRC |
| 10 | Registration number | Registration from the vehicle |
| | incorrect | device does not correspond to |
| | | the detected registration |
| | | number |
| 11 | Suspicion of | To be concluded from log file |
| | tampering with the | entry |
| | vehicle device | |
| 12 | Vehicle device or | Vehicle device blocked, for |
| | collection card blocked | example because the user does |
| | | not pay |

If the determination of the content cannot clarify whether a participant in the automatic toll-collection system has correctly paid the toll, the following data is registered and stored: case group or monitoring status, location and time of the monitoring, digital recording or recordings in order to detect the motor vehicle registration number, a digital overview image, the registration number which is determined, the associated confidence rate and—if it is determined—the country of origin or the fact that the registration number could not be read, information about the toll class of the vehicle and the associated confidence rate, the following data of the vehicle device: the complete DSRC payment data record, including the currently entered level of toll, ID and operating state of the vehicle device and its collection card, the set tariff class of the vehicle device (in the case of vehicles with a plurality of possible tariff classes), if appropriate, log file formation which is obtained and which indicates manipulation of the vehicle device.

In the case of subscribers to the funds receipt system, the following information is registered and stored in the corresponding cases: case group or monitoring status, location and time of monitoring, digital recording or recordings for detecting the motor vehicle registration number, a digital overview image, the registration number which is determined and the associated confidence rate or the fact that the registration number could not be read, information about membership of the vehicle of a toll class and the associated confidence rate, the data of the associated use authorization from the funds receipt method insofar as the registration number could be read and detected.

The identification rate designates the proportion of the vehicles which are liable to pay tolls and whose motor vehicle registration number was detected correctly either by OCR or by means of manual post-processing. With the currently developed technology and given average environmental conditions, it is expected that an identification rate of more than 80% will be achieved solely by means of automatic detection. If post-processing is added, an average value of over 90% can be expected. Given relatively poor weather conditions with reduced visibility (less than 100 m) or when there is snow on the carriageway, a value which is lower, dependent on the visibility, can be expected.

Registration numbers with arabic or cyrillic lettering cannot be read with the OCR software. For this reason, in these vehicles, the image containing the registration number is stored and passed on to the monitoring center 20 for manual post-processing.

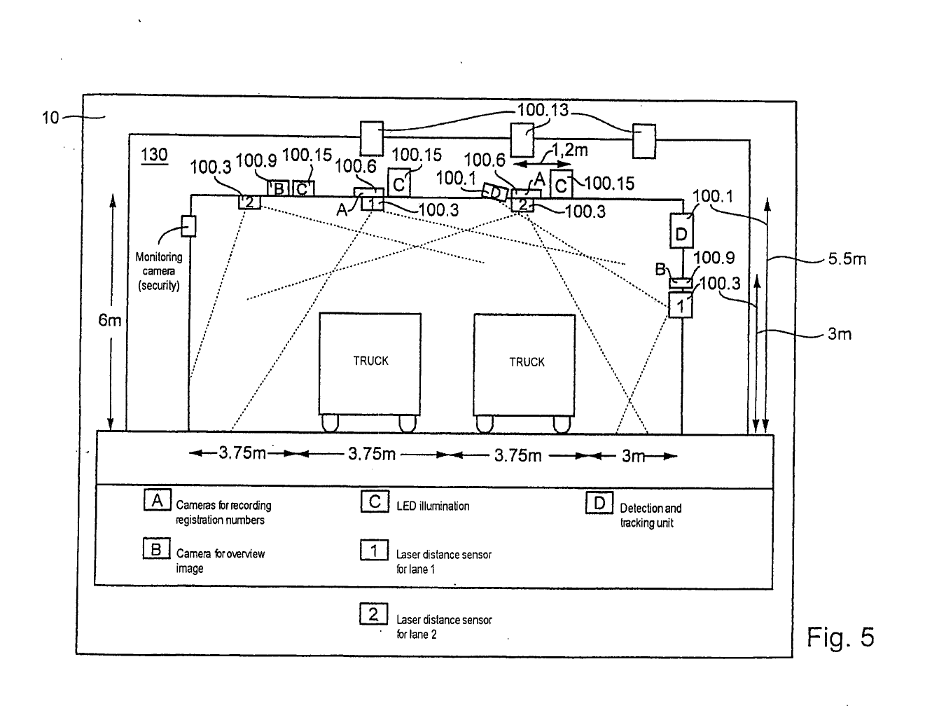

A confidence rate is calculated for each OCR reading of a registration number. This is a measure of quality of the detection. If the confidence rate drops below a defined value, the registration number is pre-positioned for manual post-processing. For the classification, two scanning laser distance sensors 100.3 (FIG. 5) measure the vehicles from two sides. The resolution of these sensors is ±150 mm for an individual point measurement. However, as this measuring error is mainly due to a statistically distributed imprecision in the determination of the transit time of the light pulse, it can be reduced to ±50 mm by averaging a plurality of measured values.

The axle counting is also carried out by means of one of these laser distance sensors 100.3. The spatial resolution is limited by the distance between the individual measuring points (1°) and the frequency of the individual scans at a specific vehicle speed. This results in vertical resolution of approximately 120 mm in the wheel region. The horizontal resolution is approximately 290 mm given a speed of 80 km/h.

A confidence rate which serves as a measure of the reliability of the assignment to a vehicle class is calculated for each classification result. At confidence rates below a threshold which is to,be defined, the classification counts as unsuccessful. As a result, the vehicle could not be unambiguously assigned to any toll class.

The ultimate determination as to whether a person who is liable to pay tolls is to be evaluated, after automatic monitoring, as a person who pays correctly, a person who pays incorrectly or a person who avoids paying tolls, takes place with respect to all certain, probable or possible infringements in the course of the post-processing in the monitoring center.

All the proof data records which are received from the monitoring system 10 for the determination of the contents are cataloged in the monitoring center 20 and stored electronically. Before the data for producing an order for the imposition of a fine is transferred to the monitoring point 40, the data records are verified. All the proof items for which the registration number could not be read, or could not be read completely, are first completed manually by inputting the registration number. Before further manual checking, there is a further automatic check of the data. This includes: checking whether the vehicle is freed of liability to pay tolls or has been registered on a voluntary basis as a vehicle below the limit for the obligation to pay a toll; an interrogation of the permitted overall weight in the Federal Motor Vehicle Authority in the case of German vehicles, the attempt to assign a DSRC payment data record; in the case of a vehicle without a vehicle device, further checking to determine whether a funds receipt data record has been submitted at the time of the monitoring; checking to determine whether the registration number in the proof data record and on the proof image correspond. To do this, the automatic monitoring systems 10 also transfer all the DSRC payment data records to the monitoring center. If a valid DSRC payment data record or a funds receipt is present or if becomes apparent that the vehicle is not liable to pay a toll, the respective person in the database is marked as a person who pays correctly or is not liable to pay a toll. Proof images and registration number information is then deleted. In all the other cases, the proof images are checked manually to determine the contents. At the start of a manual check it is determined whether faults or failures of the entire system could have erroneously led to proof data records being recorded at specific monitoring locations.

This investigation is based on the recorded technical functional status of the recording monitoring system at the time when the contents file was created and on the recorded functional faults which have occurred at the time when the proof data records were created.

Given knowledge of the system status at the time when the proof was collected, the contents are determined as follows: the identification of the registration number is checked manually and if appropriate corrected. The country of origin is input or confirmed or corrected. If the vehicle is not registered as toll-free, the appropriate trained personnel enter the toll class on the basis of the overview image.

In the case of a manual change to the registration number, as described above, a renewed assignment of a chronologically and locally matching DSRC payment data record as well as of a funds receipt data record is attempted. If these assignments are not found, if appropriate a renewed enquiry is admitted to the Federal Motor Vehicle Authority.

If the subsequent processing could not resolve the doubts (for example about the toll class or the registration number), or the assessment led to the determination “not liable to pay a toll” or “person who pays correctly”, the collected data is made anonymous and registered statistically. The proof data is cleared. If the post-processing leads to the determination “person who pays incorrectly” or “person who avoids paying the toll”, the data is stored and made available to the monitoring point 40.

The results of the determination of the content are evaluated statistically. All the proof data records on persons who avoid paying a toll are archived in the monitoring center 20. Data is cleared automatically after the legally defined storage period of 24 months. Moreover, in the course of the section-related monitoring of subscribers of the automatic toll-collection system, the monitoring center 20 passes on all the DSRC payment data records to the monitoring facility 90. These are then reconciled to determine whether the payment information has actually been transmitted to the central system. In this way, specific cases of manipulation of the vehicle device can be detected.

For all the persons who avoid paying a toll and who are determined unambiguously, there is automatic subsequent collection for the monitoring section in the funds receipt system—i.e. without user interventions—if their vehicle and a corresponding means of payment are already known in the central system. The necessary input data—time and location of the monitoring process, motor vehicle registration number, country of origin and toll class—are known owing to the monitoring. The address of the respective person is stored in the monitoring center 20 and is available for the proceedings for the imposition of a fine. If no means of payment was registered in the toll-collection system for the holder of a German vehicle, the monitoring center 20 receives his address only for the purpose of subsequent collection via the interfaces with the monitoring point 40 or with the Federal Motor Vehicle Authority. All other cases in Germany are collected in one list for each German Federal State and transferred at periodic intervals (weekly/monthly) to the monitoring point 40 for the addresses to be determined.

On the basis of the address data which is transferred by the monitoring point 40 or already known in the system, subsequent-collection orders are sent to the holders of the vehicles and the receipt of payment is monitored. If the toll class of a vehicle is determined incorrectly owing to the external characteristics of a vehicle, its holder has to challenge the subsequent collection. Correction is carried out manually in the monitoring center. Lists with outstanding demands are made available to the personnel of the monitoring point 40 for calling up so that such demands can be directly imposed in a targeted fashion during a stationary monitoring process.

The subsequent collection is carried out with staggered timing in order to ensure that a person who avoids paying a toll is not called to account twice for the same incident. For this purpose, there is first checking for duplicates. The necessary waiting time will be adjustable and depends on the time delay with which stationary and mobile monitoring facilities transmit the data on the person who avoids paying a toll to the monitoring center 20.

The stage at which detected infractions are processed can be pursued using the state attribute which is assigned to a specific infringement. These state attributes represent the necessary basis for the monitoring of the receipt of payment within the framework of the subsequent collection process and the proceedings for the imposition of a fine. If payment is not received in a period which can be defined, the case is transferred to the monitoring point 40 for further processing. The monitoring point 40 then produces its own subsequent collection orders.

The monitoring point 40 is equipped with PC workstations which have access to the case database of the monitoring center 20 via a fixed link for the transmission of data. Such access fulfills the following functions: when the function “create order for the imposition of a fine” is selected, the current case is displayed on the screen and possible previous incidents relating to the same vehicle are indicated. The employee can look at the current proof images or load details on the previous cases. He can select or enter the level of the fine. It is possible to implement linking to amounts, also subsequent collections, from cases which are not yet terminated. The address of the person who has avoided paying a toll is called up via an interface with a computer of the monitoring point 40, and automatic printing and dispatching of the order for the imposition of a fine are initiated. If an address (for example of foreign holders of vehicles) is not available, it can also be input manually.

As confidential data, such as records of payment, is transmitted between the automatic monitoring system, the vehicle device and the monitoring center 20, there is provision for the communications links to be protected cryptographically. These measures prevent unauthorized monitoring or modification of the messages and of the proof items. Glass fibers links are predominantly used between the components of the monitoring system 10. This rules out monitoring by third parties. The recorded proof items are stored at maximum until the contents are determined, and in the event of an infringement being determined they are stored for the legal storage period of 24 months.

In addition to the actual monitoring and the post-processing, a series of additional sequences is necessary to support the monitoring process: the updating of the blocked lists for the collection cards of the vehicle devices in the monitoring systems 10, the interrogation of individual entries of the white list which is kept in the monitoring center 20, and the vehicles which are registered as free of tolls, marking of the funds receipt records of the vehicles which are registered by the monitoring systems 10 in the white list, the updating of the cryptographic keys via an interface with the security center, the transfer of all the DSRC communications records from the monitoring system 10 to the monitoring center 20, and the transfer to the monitoring system in order to check receipt of the payment data in the central system, supply and updating of the monitoring systems 10 with tariff data, administration of a classification database, in particular the entry and removal of vehicle data, acceptance and evaluation of statistical data of the monitoring systems 10 and forwarding them to the monitoring system, the acceptance of a maximum of fifty motor vehicle registration numbers (with country of origin) by the monitoring system for selective logging of monitoring of these vehicles. The last item includes the transfer of these registration numbers to all the monitoring systems 10, the logging of each passage through the monitoring systems 10 with the monitoring result and the transfer of this data to the monitoring system via the monitoring center 20.

The automatic monitoring facilities (automatic monitoring systems) are mounted on carriers 130, referred to as “bridges”. The bridges 130 can be walked on for maintenance purposes, and therefore have a rail. In addition to the bridges 130 there is in each case a supply station for the accommodation of the mains connections and computers. The sensors which are provided make it possible to dispense with building double bridges. As a result, adverse effects on the appearance of the countryside are kept as small as possible. The design of the automatic monitoring system is presented below. In order to obtain the required properties, the automatic monitoring system contains various optical sensor units. These are in particular, per lane: a combined laser distance sensor/camera system for detecting and tracking the vehicles 100.1, scanning laser distance sensors 100.3 for generating a 3D image of the vehicle and for measuring features with which the vehicle can be classified as a truck above 12 t, camera/lighting units for recording and determining the motor vehicle registration number 100.6, camera/lighting units for recording an overview image of the truck 100.9.

In addition to the optical sensor units, the system is also composed of communications and service units. These are: a communications module 100.12 (ISDN fixed link and ISDN dial-up link). The ISDN dial-up link serves as a backup as well as an additional channel which can be used for stationary monitoring for the online interrogations, while the proof items are transmitted over the ISDN fixed link. A DSRC module 100.13 (DSRC beacon) for communication with the vehicle devices. Here, infrared technology is used as only this technology can also be used for mobile monitoring. A cryptomodule for encryption and decryption of the messages and for generating a digital signature of the proof items. For cases in which subsequent stationary monitoring is provided, a further communications module is available for exchanging data with the stationary monitoring facility. The technology to be selected depends here on the local conditions at the location of the monitoring system, for example on the distance from the leading-off point 200.2.

In order to safeguard the functioning of the overall system, there is cyclical monitoring of the system state. An alarm is activated if necessary.

The following table describes the properties of the individual system components in detail:

| Component | Description |
|---|---|
| CCD camera 100.1, | Special high-resolution camera which is |
| 100.6, 100.9 | sensitive in the near infrared range and can be |
| | asynchronously shuttered. The lighting |
| | parameters can be adapted to the ambient |
| | conditions during operation by means of an |
| | external interface. The signal is transmitted |
| | via optical waveguides. |
| Lamps 100.15 | LED flash in the near infrared range with |
| | extremely high light yield. |
| Detection unit 100.2 | The detection of vehicles does not require a |
| | second bridge but is rather carried out by |
| | means of laser distance sensors which have |
| | become established in the field of autonomous |
| | vehicle guidance. |
| Measuring sensors | The 3-D measurement of the trucks for the |
| 100.3 | purpose of classification is carried out by |
| | means of two 3-D laser distance scanners. |
| DSRC beacon 100.13 | Infrared DSRC beacon or possibly 5.8 GHz |
| | DSRC beacon |
| External data | Via ISDN |
| communication 100.12 | |
| Computer 100.4, | Standard industry PCs which are optimized for |
| 100.5, 100.7, 100.8, | a long service life, installed in an air- |
| 100.10, 100.11, | conditioned switch cabinet |
| Internal | 100 Mbit Fast Ethernet Network with switch |
| communication | |

The position of the various components on the bridge is represented using the example of the equipment of two lanes of a three-lane freeway in FIG. 5. For the sake of better clarity, the sensor boxes and the corresponding components for the third lane and the hard shoulder are not included, with the exception of the DSRC beacons 100.13 above the hard shoulder.

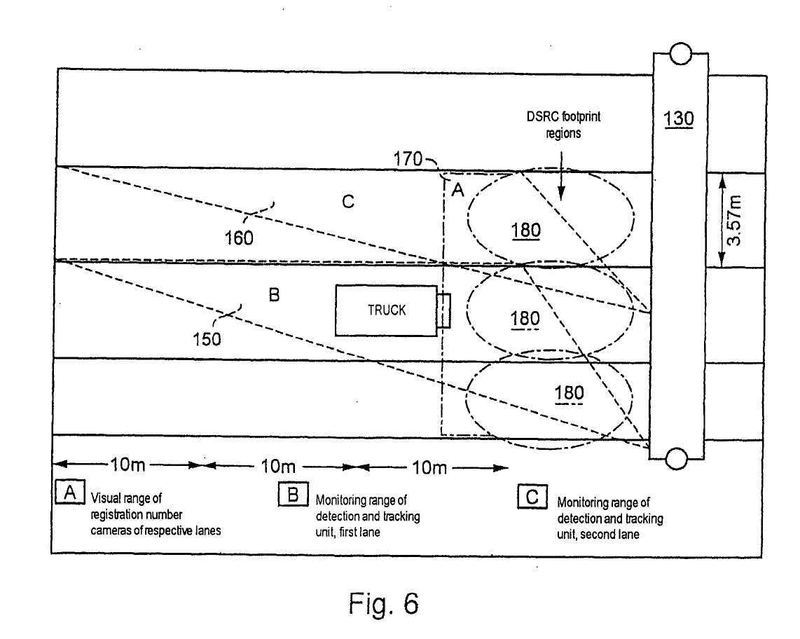

The cameras for the lane which is to be respectively monitored are installed 100.6, 100.15 directly over the center of the lane. The associated lighting systems are located at a certain distance from them. The detection and tracking units 100.1 monitor the flowing traffic from an oblique angle above the adjacent lane. The detection sensors 100.1 for the center lane are therefore mounted above the right-hand lane. The laser distance sensors 100.3 (3D scanners) for the right-hand lane are located above the central lane and on the side of the bridge carrier. The laser distance sensors 100.3 (3D scanners) for the center lane are mounted symmetrically above the lane to the right and left of said lane. The cameras for the overview images 100.9 are installed on the side bridge carrier for the right-hand lane and above the neighboring lane for the center lane. As is shown by FIG. 5, a few sensors are mounted on the bridge 130, while mounting on the upright post of the bridge is more favorable for other sensors. The measuring ranges 150, 160, 170, 180 of the individual sensors are shown by FIG. 6 in a plan view.

The method of operation of the vehicle detection system is explained in more detail below. The image processing system 100.2 determines the lane profile in the camera image in an initialization phase, and a so-called sliding background image. Moving vehicles are detected as disruptions in this background image and are assigned to a specific position on the basis of the lane profile and the known optics. This unit uses daylight as illumination, and the headlights of oncoming vehicles at night. The laser distance sensors 100.3 monitor the respectively set visual range 150, 160, determine visual ranges on the basis of the backscattered signals and carry out distance measurement for the vehicles which are discovered, and thus determine their speed. The detected vehicles are assigned to a lane on the basis of the tracking and the geometric positioning by means of the sensor. As a result, all the approaching vehicles are detected as a vehicle independently of their travel class, their speed and their distance, and the speed and the distance of the vehicles are estimated. The time for the use of the respective sensors to record images and perform classification is determined from this.

Vehicles which follow in close succession are generally received as two separate vehicles unless they are traveling extremely close to one another and a long way away. In this case, during a renewed measurement cycle at a smaller distance the system will separate the previously joined objects. Conversely, in the case of a truck with trailer which is incorrectly detected as two objects, the objects will also be fused. The front of the vehicle is tracked up to a distance of 6 m from the bridge. However, the laser distance sensor 100.3 generally also detects the side of the vehicle so that even thereafter, it is still possible to draw conclusions about the whereabouts of the vehicle between the exiting of the detection range and the measurement range of the 3-D scanners 100.3. This is essential for handling a congestion situation.

In addition, the information from the DSRC modules 100.13 is added for tracking the vehicle. The data of the units 100.1+100.3 of each lane is combined in an evaluation unit 100.2. In this way, even lane changes and vehicles which are traveling between two lanes can be correctly detected and administered. In the event of congestion, the 3-D scanners 100.13 are switched by the trigger of the detection unit 100.2 into a standby mode in which they wait for an object in a specific distance range. If an object occurs in this range, data is recorded until the object has passed the monitoring facility. In this way, a lane change between the end of the detection range of the detection cameras 100.1 and the measuring range of the 3-D scanners 100.3 is taken into account by virtue of the fact that more than just one pair of scanners is switched to standby mode.

The detection ranges 150 and 160 are made of the detection ranges of the detection cameras 100.1 and the measuring ranges of the scanners 100.3. The detection range of the registration number cameras is indicated by 170 in FIG. 6.

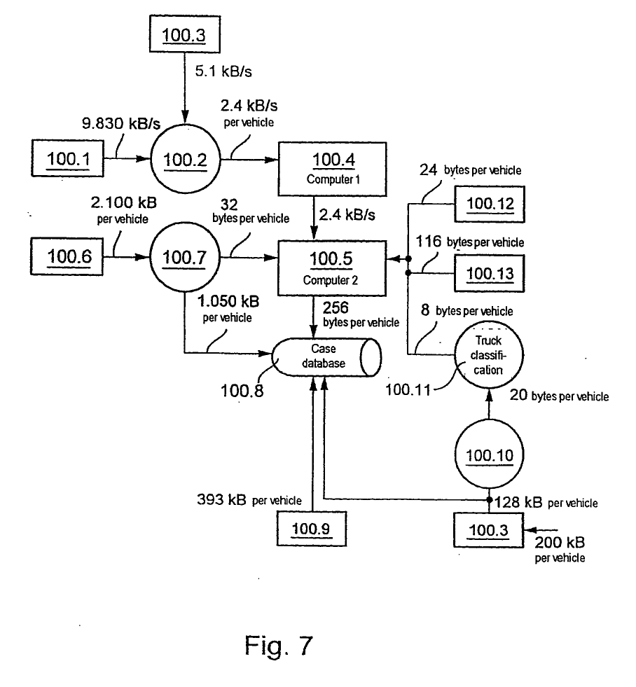

The detection unit 100.2 (FIG. 7) forms the backbone of the system, as only one vehicle that has been detected can also be handled and processed as such. The combination of the information from the individual components is carried out on a central control computer. It will also handle measurement failures during individual measurements and the combination of information from a plurality of sensors.

The part-processes of the individual components communicate with one another by means of TCP/IP. The recording of measurement data (ie., the synchronization of the individual method steps) is controlled by signaling to the sensor system a system time at which a measurement is to take place. The data necessary for this is transmitted simultaneously by TCP/IP.

In the monitoring center 20 of the toll system, each workstation has, for the purpose of manual post-processing, a PC with access to a central database server system. A communication server, an administration workstation and cryptocomponents are made available for operating the external interfaces and other functions. For reasons of availability the components are configured redundantly.

In the control point 40, each workstation has, for the subsequent collection and generation of orders for the imposition of fines, a PC with access to the central database server system of the monitoring center 20 of the toll system operator. For this purpose there is a continuous online connection between the monitoring center 20 and the monitoring point 40 with the necessary bandwidth. In addition to a communication server and a cryptocomponent for operating the external interface there is a database for storing person-related data of the holders of the vehicles.

FIG. 7 is a schematic view of the data flows in the monitoring system 10. It is to be noted that the data sets relate partially to seconds and partially to a vehicle.

Here it becomes clear that an enormous reduction in data takes place between the registration devices 100.1, 100.3, 100.6, 100.9, 100.12 and 100.13 and the control functions 100.2, 100.4, 100.5, 100.7, 100.8, 100.10 and 100.11. For example the registration number images have a data volume of more than 2.1 Mbytes, while the information acquired from them—the registration number—has 32 bytes. Very large data sets are sent between the individual computer units only from the image recording processes 100.7, 100.9, 100.10 to the case database 100.8. Here, the transmitted data sets are reduced because the image data is not sent until the preselection has not classified any “vehicle which is clearly not liable to pay a toll”. Furthermore, the volume of the image data contained is reduced further by selective, but not completely loss-free reduction in the steps “identification of the relevant excerpts”, “cutting” and “compressing”. In this way, the volume per tracking case can be expected to be reduced to approximately 200 kbytes.

| Data flow | | | |
|---|---|---|---|
| from-to | Data contents | Size | |
| Detection camera | Camera images of the | 9830 | kbytes/s |
| 100.1-detection unit | approaching vehicles | | |
| 100.2 | | | |
| Laser distance sensor | Distance data of vehicles | 5.1 | kbytes/s |
| 100.3-detection unit | | | |
| 100.2 | | | |
| Detection unit 100.2-computer | Distance data from vehicles | 2.4 | kbytes/s |
| 1 100.4 | from the environmental model | | |
| Computer 1 100.4-computer | Distance data of the respective | 2.4 | kbytes/s |
| 2 100.5 | vehicle | | |
| Recording of | Registration number images | 2100 | kbytes |
| registration number | from the entire width of the lane | | per vehicle |
| image 100.6-reading | | | |
| of registration | | | |
| number 100.7 | | | |
| Reading of | Registration number | 1050 | kbytes |
| registration number | image/images in which the | | per vehicle |
| 100.7-case database | registration number is located | | |
| 100.8 | | | |
| Recording of overview | Overview image | 393 | kbytes |
| image 100.9-case | | | per vehicle |
| database 100.8 | | | |
| 3-D scanner | Conditioned 3-D data from two | 128 | kbytes |
| evaluation 100.10-case | laser distance sensors | | per vehicle |
| database 100.8 | | | |
| 3-D scanner | Results of the length, width and | 20 | bytes per |
| evaluation 100.10-truck | height measurements as well as | | vehicle |
| classification | the counting of axles | | |
| 100.11 | | | |
| Reading registration | Result of reading of registration | 32 | bytes per |
| number 100.7-computer | number | | vehicle |
| 2 100.5 | | | |
| GSM/ISDN module | Funds receipt data record etc. | 24 | bytes per |
| 100.12-computer 2 | | | vehicle |
| 100.5 | | | |
| DSRC module 100.13-computer | Data transferred from vehicle | 116 | bytes |
| 2 100.5 | via DSRC | | per vehicle |
| Lorry classification | Result of classification | 8 | bytes per |
| 100.11-computer 2 | | | vehicle |
| 100.5 | | | |
| Computer 2 100.5-case | Evaluation of results | 256 | bytes |
| database 100.8 | | | per vehicle |

Stationary monitoring is carried out on selected car parks in the freeway network and is always based on automatic preselection by an automatic monitoring system. For this purpose, the monitoring point 40 determines 150 monitoring stations and deploys 70 monitoring groups. During the stationary monitoring, the determination of the contents (by the automatic monitoring system) is carried out in situ, as well as the detection of the contents (by personnel of the monitoring point). The subsequent collection and the imposition of a fine are either also carried out locally, or centrally by the monitoring point.

Information on vehicles for which monitoring is required and which have been determined by the automatic monitoring system is transferred via the link between the automatic, fixed monitoring system and the transportable monitoring system. Here, case groups are distinguished in accordance with the following table:

| Case group | | |
|---|---|---|
| No. | Case group | Explanation |
| 1 | Not liable to pay a | Detected by reference to the |
| (is not | toll | vehicle features or the |
| registered) | | registration number |
| 2 | Detected as person | Functioning vehicle device |
| (is not | who pays correctly | |
| registered) | | |
| 3 | Registration number | No DSRC communication, |
| | not detected | receipt of funds cannot be |
| | | checked |
| 4 | Doubts about | Vehicle features unclear |
| | obligation to pay toll | |
| 5 | Doubts about | DSRC communication available |
| | fulfillment of | but assignment to a vehicle not |
| | obligation to pay toll | unambiguous as registration |
| | | number not legible |
| 5 | Doubts about | No functioning vehicle device |
| | fulfillment of | and registration number not |
| | obligation to pay toll | detected |
| 6 | Detected as person | Different toll class |
| | making incorrect | |
| | payment | |
| 7 | Detected as person | No functioning vehicle device |
| | who does not pay | and no receipt of funds for |
| | | registration number |
| 8 | Detected as person | Receipt of funds for the vehicle |
| | who does not pay | is used twice |
| 9 | Detected as person | No payment record for current |
| | who does not pay | section transmitted via DSRC |
| 10 | Registration number | Registration number from |
| | incorrect | vehicle device does not |
| | | correspond to the detected |
| | | registration number |
| 11 | Suspicion of | Can be concluded from log file |
| | manipulation of | entry |
| | vehicle device | |
| 12 | Vehicle device or | Vehicle device must not be used |
| | collection card | again, for example because the |
| | blocked | user does not pay |

Automatic preselection as part of the automatic monitoring ensures that vehicles which are detected as not liable to pay a toll are not made available to be diverted. For targeted and flexible diversion, it is possible for the number of vehicles which are to be provided for stationary monitoring, and thus indicated to the diversion point, to be determined locally after any desired combination of case groups. By corresponding setting of the diversion filter, it is possible for the monitoring group to facilitate or prevent a situation in which people who pay correctly are indicated for diversion. The vehicles which are determined for the selected case groups are indicated to the diversion point. However, a decision about diversion is always ultimately taken by the member of the personnel at the monitoring point 40 who is authorized to do so, after a proposal by the automatic monitoring system. This is necessary to take into account the capacity of the monitoring station 200.3 and of the monitoring personnel. Diversion itself is carried out manually by a member of the personnel of the monitoring point. If such member does not operate the diversion aid himself, it may also be performed by a further member of personnel and such person can inform the member of the personnel of the monitoring point 40 about the trucks to be diverted by calling up or—if present—by radio telephony. The selection of a suitable communications link ensures that the information of the automatic monitoring system is displayed on the diversion device at the latest after 10 seconds. The communications link is location-dependent.

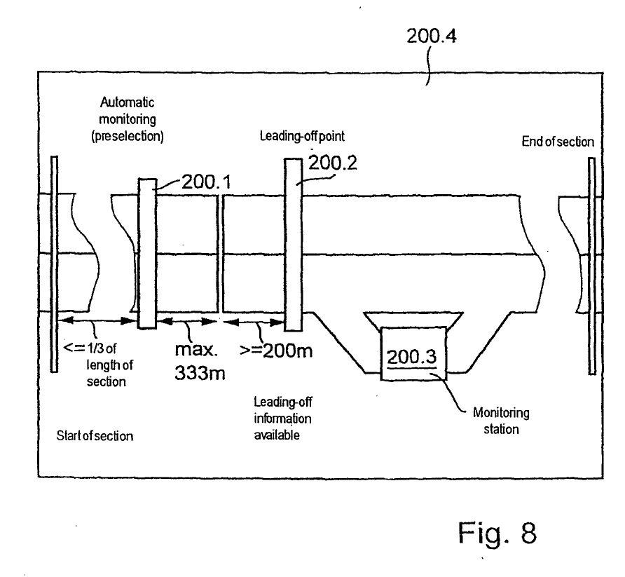

The decision about the payment of the toll on a route section is made by the vehicle device within the first third of a route section if such section is longer than 2 km. As a result, monitoring is possible in each of these sections if a monitoring bridge can be installed farther on in the section, and a car park which is suitable for monitoring is located at a sufficient distance therefrom. The arrangement of the automatic monitoring system with preselection, of the diversion point and of the monitoring station 200.3 is illustrated schematically in FIG. 8. The minimum distance between the automatic, fixed monitoring system and the diversion point is determined by the sum of the time intervals which are necessary at a vehicle speed of 120 km/h for calculating the determination of the contents and for transmitting images. In addition to this there are 200 m as a pre-warning distance for the member of personnel from the monitoring point who is performing the diversion operation. The monitoring data which is necessary for the diversion for stationary monitoring is present at the stationary monitoring facility at the latest 10 seconds after the vehicle has passed through the automatic monitoring system. In this time, a vehicle traveling at a speed of 120 km/h covers 333 meters. The distance between the automatic monitoring system and the diversion point will therefore generally be at least 533 meters. In the upward direction, the distance between the automatic monitoring system and the diversion point 200.2 is limited only by the range of the transmission medium for the monitoring data. The transmission medium for each individual link of the communications links which are required is selected in an optimized fashion according to commercial and technical criteria. Under the aforesaid conditions, a stationary monitoring facility can be set up on a freeway section between a point approximately 1200 meters from its start and the end of the section without further restrictions. If a shorter processing and transmission time is necessary as a result of the distance between the automatic monitoring system and the diversion point 200.2, this can also be ensured given a maximum frequency of one truck per second down to a lower limit of a minimum of four seconds if a corresponding cable or broadband radio link is used. Taking into account the aforesaid pre-warning distance, approximately 300 m is the minimum distance between the automatic monitoring 200.1 and the diversion point 200.2.

For diversion of vehicles which require monitoring, the automatic monitoring facility 200.1 transmits the motor vehicle registration number to the stationary monitoring facility, and an image of the vehicle together with information about the reason for the diversion recommendation.

This data is conditioned and clearly displayed to the member of personnel of the monitoring point 40 on a device suitable for that purpose. By reference to this representation, the member of personnel makes the decision as to whether to actually divert a specific vehicles.

The automatic monitoring system transmits the following information on vehicles detected by the currently set leading-off filter to the stationary monitoring facility: an overview image of the vehicle (in black and white, in a compressed format), the registration number or the message that such number has not been detected, the nationality of the vehicle or the message that this has not been detected, the case group, toll-related parameters from the funds receipt operation or the setting of the vehicle device, if appropriate the type of incorrect payment (registered versus determined toll class), if appropriate indications of manipulation (as a code number or in plain text).

During the checking at the monitoring station 200.3, there is the ultimate determination of the contents to determine whether the driver or holder of a diverted vehicle is to be evaluated as a person who pays correctly, as a person who pays incorrectly or as a person who avoids paying a toll. For this purpose the monitoring group uses special monitoring systems 10. On the one hand these may call up current fund receipt data, via a GSM interface, for a specific motor vehicle registration number in the monitoring center 20. On the other hand, they may interrogate data from the vehicle device via the DSRC or a cable link to test whether said device is operating satisfactorily or whether a fault has been detected.

The monitoring group receives in particular the following information via this interface: all the log sets which can be interrogated in individual categories and by reference to which it is possible to determine, inter alia, which collection data has been transmitted to the center at what time,, the configuration data of the vehicle device, inter alia the stored motor vehicle registration number, the version of the software used for the vehicle device, the result of a check as to whether the software has been manipulated or not.

The monitoring group has to check the vehicle papers and also investigate whether the vehicle device is undamaged. In the case of nonpayment it can determine whether this has been caused by a system fault or by an intervention by the user. If the monitoring group has detected an infraction, it is capable of interrogating historical data on infraction associated with this vehicle via the GSM link in the monitoring center 20 in order to be able to determine an appropriate fine. If the result of the determination of the contents is that in one case the person is someone who pays incorrectly or who avoids paying a toll, the associated data is stored and transmitted to the monitoring center 20 after monitoring. The results of the determination of the contents are evaluated and archived statistically in the monitoring center 20. This data is cleared automatically after the legal storage period of 24 months.

The data which is associated with stationary monitoring relates to the data which the automatic monitoring system transmits to the diversion aid of the monitoring group and the data which is transferred to the monitoring center 20 after the process of the determination of the contents by the monitoring group.

The data generated for diversion is cleared in the diversion aid after the next vehicle is displayed, and after a waiting time of one minute. The monitoring data of each vehicle which is identified as that of a person who avoids paying a toll is transmitted to the center. This data comprises in particular the time and location Of the monitoring, the identification of the monitoring group, the motor vehicle registration number and the nationality of the vehicle, holder data (determined from the submitted vehicle papers), permissible overall weight, number of axles and emissions class of the tractive unit, trailer/semitrailer (yes/no), the toll class of the vehicle, the type of infraction detected, subsequent collection carried out (yes/no), if appropriate the level of the subsequently collected toll, level of fine determined and imposed (yes/no), if appropriate the level of the fine collected, data from the vehicle device which proves the infraction. This information is collected automatically by the application on the basis of the type of infraction which is input by the member of personnel of the monitoring point 40.

The toll is generally collected directly from the user at the car park, in particular if later imposition appears improbable. In order to avoid unjustified double subsequent collections, the information on subsequent collections is transmitted at least once a day to the monitoring center. If, in exceptional cases, it is not possible to transmit the monitoring cases at the correct time into the monitoring center 20 due to a fault in the technical systems, it is necessary to ensure in organizational terms that double collection is prevented. This is carried out by a written documentation of the monitoring cases and the obligation to signal these cases by telephone to a member of personnel of the monitoring center 20 after the monitoring operations have been concluded.

Orders for the impositions of fines can be generated and executed directly in situ by the monitoring group. In order to be able to determine the correct level of the fine and if appropriate to impose old fines which have not been imposed, historical data on infractions associated with the monitored vehicle are interrogated via GSM. The monitoring data which is transmitted to the monitoring center 20 is correspondingly labeled in order to prevent double generation of orders for the imposition of fines.

Only information which is visible in any case is transmitted between the automatic monitoring system and the diversion aid (for example, the overview image and the registration number of the vehicle) or incomprehensible information such as the code for the content which is determined. As the transmission passage can generally be inspected by the monitoring personnel, attacks aimed at changing data are not possible without being noticed. Such changes would also be immediately apparent during the stationary monitoring. For this reason, special measures for protecting these data are not necessary. For interrogations of the monitoring system at the monitoring center 20, cryptographic methods are used in order to ensure the authenticity of both sides as well as data protection and confidentiality. In order to be able to apply the same methods for all forms of monitoring, there is provision for a chip card to be used for the monitoring groups. As in the case of the automatic monitoring, when an infraction is detected, the recorded proof is stored at least for the duration of the fixed storage period of 24 months.

In addition to the monitoring process described above, a series of additional, supporting sequences are also necessary. They are part of the sequences which are necessary for the automatic monitoring systems: the switching over of the operating mode of the automatic monitoring station to “stationary monitoring” in order to ensure authorization by means of cryptographic methods (this function being carried out by the monitoring systems 10 via the monitoring center), updating of the locking lists for the collection data of the vehicle devices in the monitoring systems 10, marking of the funds receipt records of the vehicles which are signaled by the monitoring systems 10 in the white list of the monitoring center, transfer of all the DSRC communications records from the monitoring systems 10 to the monitoring center 20 and the transfer to the monitoring system for the checking of the reception of the collection data in the central system, the supply and updating of the monitoring systems 10 with tariff data. In order to support the quality assurance, detected possible malfunctions of the vehicle device, for which the user is obviously not responsible, are logged. These records are transmitted to the monitoring center 20.

The members of personnel of the monitoring point 40 use data-radio-enabled transportable computers as a monitoring system 10 for stationary monitoring at the leading-off point 200.2. These computers are equipped with software which permits access to the databases in the monitoring center 20. Moreover, they have technical interfaces for checking vehicle devices and for reading out log files. If the DSRC interface is implemented in the microwave range, a cable link can be used. The monitoring systems 10 for monitoring vehicles have sufficient free storage space in order to able to store all the monitoring data of one day, and a chip card reader for authenticating the monitoring personnel.

Depending on the distance between the automatic monitoring system and the diversion point 200.2 and structural conditions, the following are possible, for example, to the communications link between the automatic monitoring system and the diversion aid: (a serial) link via existing cable (shafts) to corresponding power drivers, a link to special directional antennas using freely available radio methods, (for example 2.45 GHz radio, DECT, WLAN) in order to overcome the limitation on power and range, special directional radio systems such as are used for connecting LANs over property boundaries, a link via GSM (for example using the HSCSD or GPRS services) given an unfavorable position or distance.

A switching cabinet, which permits an employee of the monitoring point 40 to establish a wire-free connection, for example using Bluetooth, and thus provides no mechanical attack points, is installed at the diversion point 200.2 independently of the selected method. The installations for communication with the automatic monitoring can be supplied with current via existing cables or using a small photovoltaic system.

The interface between the portable monitoring system for stationary monitoring and the monitoring center 20 20 corresponds essentially to that between the automatic monitoring system and the monitoring center, only the former can additionally interrogate historical data on infringements and can switch over the operating mode of the automatic monitoring facility. The information on earlier infringements associated with a vehicle comprises the following data: time and location (section of route) of the infringement, the type of infringement, the level of the subsequently collected amount, the level of the fine, a note about when and whether the subsequently collected amount and/or fine could be collected.

As comparatively few vehicles are monitored, and recording and transmission of a proof image is dispensed with, it is possible to use a GSM link without difficulty.

Mobile monitoring is based on monitoring groups which join the flow of traffic with a monitoring vehicle and monitor trucks (i.e., carry out a determination of facts) while driving past. If there is a suspicion of infringement against the obligation to pay a toll, the respective vehicle is diverted to a car park or into a suitable freeway exit for the establishment of facts.

The mobile monitoring groups patrol the flowing traffic and monitor vehicles by spot checks. They are equipped with monitoring systems 10 which make it possible to communicate with the vehicle device of a truck via its DSRC interface, and to communicate with the monitoring center 20 in order to check trucks which are not equipped with a vehicle device. As in the case of automatic monitoring, the data of the vehicle device from participants in the automatic collection method are available virtually immediately. As the mobile monitoring system can access the vehicle device via DSRC, the data is presented in less than five seconds.

As a result of the analysis of the received data, the following case groups (analogous to those of the automatic preselection) are distinguished:

| Case group | | |
|---|---|---|
| No. | Case group | Explanation |
| 1 | No response | No vehicle device or vehicle |
| | | device defective |
| 2 | Person who pays | Correct funds receipt with |
| | correctly detected | vehicle device |
| 9 | Person who does not | No payment record for the |
| | pay detected | current section transmitted via |
| | | DSRC |
| 11 | Suspicion of | To be concluded from log file |
| | manipulation of vehicle | entry |
| | device | |
| 12 | Vehicle device or | Vehicle device is blocked, for |
| | collection card blocked | example because the user does |
| | | not pay. |

In order to be able to check the payment of a toll by a vehicle in case group 1, it is necessary to access the white list compiled in the monitoring center 20. To do this, the monitoring center 10 has an input possibility for the registration number and the nationality of a vehicle. After each individual input of a registration number, an online interrogation is carried out in the monitoring center 20 for this purpose. A connection to the monitoring center 20 is already while the registration number is being input. This makes it possible to ensure that checking can take place and the response time remains below five seconds. Exceptional cases are possible only when there is no GSM supply or if a user sends the funds directly before starting his journey, as soon as he drives onto the freeway and is immediately monitored, as the data may take several tens of seconds to travel from the payment location via the funds receipt center to the monitoring center 20. If there is no communications link, corresponding information is displayed on the monitoring system 10.

The monitoring is supported by an autonomous facility for determining position and direction of travel in the monitoring system. The mobile monitoring can be carried out on any desired section of a route as it is independent of resources which are tied to locations and has its own communication paths to the vehicle device and to the center. In the case of an infraction, the monitoring group diverts the vehicle to a car park or to an exit in order to establish facts.

The evaluation of the DSRC communication is indicated to the member of personnel of the monitoring point 40 with explanatory data on the monitoring system 10. By reference to this representation he or she makes the decision actually to divert a specific truck or not. The monitoring system 10 displays the following data which is received via the DSRC interface or derived from it: the case group according to Table 6, the motor vehicle registration number, the nationality of the vehicle, the payment data record (date, time, section of route, paid toll, toll class), if appropriate indications of manipulation (as code number or in plain text). In the case of vehicles without a vehicle device, for which reconciliation in the white list has been carried out, the following data is displayed: valid receipt of funds present (yes/no), funds receipt number, start and end of validity, the toll parameters (permitted overall weight, number of axles, emissions class).

The establishment of facts by the monitoring group is carried out precisely as in the case of stationary monitoring. The data for the establishment of facts is the same as in the case of the stationary monitoring and is transferred to the monitoring center 20. Subsequent collection of the toll is carried out either by means of the monitoring group directly from the user or later by means of the center of the monitoring point.

Orders for the imposition of a fine are generally generated directly in situ by the monitoring group and imposed. In all other cases, the orders for the imposition of a fine are generated later in the monitoring point 40.

The information is transmitted between the monitoring system 10 and the vehicle device in encrypted form via the DSRC interface. The methods which are to be used for this are identical to those for automatic monitoring. For the interrogations of the monitoring system at the monitoring center 20, cryptographic methods are used in order to ensure the authenticity of both sides as well as data protection and confidentiality. In order to be able to apply the same methods for all forms of monitoring, there is provision for a chip card to be used for the monitoring groups. When an infraction is detected, the recorded proof items are stored, as in the case of automatic monitoring, at least for the fixed storage period of 24 months.

In the monitoring vehicles, the DSRC transmitter (infrared) is fixed for the sake of better handling, but is mounted in a rotatable and pivotable fashion. A microwave transmitter is mounted on the vehicle if possible.

The monitoring systems 10 are equipped with an autonomous section-detection module in order to detect and represent the section which is being traveled on at a particular time, and said monitoring systems 10 are connected in the vehicle to a GPS antenna. The interrogation of the data from vehicle devices is carried out by a DSRC infrared transceiver component which is connected via a cable link to the actual monitoring system 10. Communication with the monitoring center 20 is carried out via a suitable communications interface (GSM/GPRS). For communication with the vehicle device it is preferred to use an infrared interface rather than the microwave interface (5.8 GHz). According to the DSRC standard for 5.8 GHz and manufacturing information, the necessary bit error rate can be ensured for a distance of only up to 2.6 m between the monitoring system 10 and the vehicle device, given the maximum permitted transmitting power of 18 dBm. In contrast, significantly higher distances (up to 40 m) can be covered using an infrared interface with a correspondingly equipped transmitter which strongly focuses the transmission power in the direction of the vehicle device. For manual monitoring, the monitoring system 10 can very easily be removed from the vehicle and then used precisely as for stationary monitoring. The devices for manual vehicle monitoring have sufficiently free storage space in order to be able to store all the monitoring data from one day, as well as a chip card reader for authenticating the personnel of the monitoring point.

Owing to the large number of possible funds receipt operations per section of freeway it is advantageous not to keep a copy of the white list of the monitoring center 20 in the monitoring systems 10 and to continuously update it.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A monitoring method for registration of road tolls with a monitoring system having a plurality of registration devices for registering vehicle information, and a trigger device for correctly timed activation of the registration devices at registration times at which spatial arrangement of the vehicle and a respective registration device is at an optimum, said method comprising:
respective registration devices registering various vehicle information items, separately in spatial and chronological terms;
said monitoring system assigning said vehicle information items to the vehicle and to a reference time; and
transforming vehicle information relating to a registration time into vehicle information relating to a corresponding reference time.

2. A monitoring method for registration of road tolls having a monitoring system with a plurality of registration devices for registering vehicle information, and a trigger device for correctly timed activation of the registration devices at registration times at which spatial arrangement of the vehicle and a respective registration device is at an optimum, various vehicle information items which are registered separately in spatial and chronological terms by respective registration devices being assigned by the monitoring system to the vehicle and to a reference time, wherein:
fixed monitoring systems are provided for automatic monitoring;
transportable monitoring systems are provided for mobile monitoring;
a combination of said fixed and transportable monitoring systems is used for stationary monitoring; and
an operating mode of the automatic monitoring station is switchable to stationary monitoring.

3. A monitoring method for registration of road tolls, comprising:
a monitoring system with a plurality of registration devices for vehicle information; and
a trigger device for the timed activation of the registration devices; wherein
the monitoring system is transportable and can access databases in a monitoring center.

4. The monitoring method as claimed in claim 1, wherein the registration devices can be activated automatically or manually.

5. The monitoring method as claimed in claim 2, wherein the registration devices can be activated automatically or manually.

6. The monitoring method as claimed in claim 3, wherein the registration devices can be activated automatically or manually.

7. The monitoring method as claimed in claim 1, wherein:
the registration devices comprise at least one of communication devices, visual recording devices and audible recording devices;
the vehicle information comprises at least one of movement information, noise information, number plate information and outline information; and
the monitoring system includes a classification device that assigns the vehicle to a vehicle class.

8. The monitoring method as claimed in claim 7, wherein the recording devices are activated automatically or manually by the trigger device.

9. The monitoring method as claimed in claim 1, wherein:
fixed monitoring systems are provided for automatic monitoring;
transportable monitoring systems are provided for mobile monitoring; and
a combination of said fixed and transportable monitoring systems are used for stationary monitoring.

10. The monitoring method as claimed in claim 1, wherein vehicle information which is assigned to a vehicle and to a reference time is transmitted from the monitoring system to an external recipient by means of communication devices.

11. The monitoring method as claimed in claim 1, wherein vehicle information which is assigned to a vehicle and to a reference time is compared with contents of a database to determine whether a road toll has been satisfactorily paid.

12. The monitoring method as claimed in claim 11, wherein if there is a suspicion of incorrect payment, the vehicle information is also recorded as proof.

13. The monitoring method as claimed in claim 12, wherein the vehicle information that is used for detecting correct payment and the vehicle information which are used as proof is the same.

14. The monitoring method as claimed in claim 1, wherein:
for stationary monitoring, vehicle information which is assigned to the vehicle and to the reference time is transmitted to monitoring personnel; and
vehicles for which there is a suspicion of incorrect payment are diverted from a traffic flow.
